(19) United States
(12) Patent Application Publication
(10) Pub. No.: US 2025/0013508 A1
(43) Pub. Date: Jan. 9, 2025

(54) AUTOMATED APPLICATION PROGRAMMING INTERFACE CREATION

(71) Applicant: ServiceNow, Inc., Santa Clara, CA (US)

(72) Inventors: Yasser Khaled Hamed, San Jose, CA (US); Roger Lee Hagen, Mason, IL (US)

(21) Appl. No.: 18/217,877

(22) Filed: Jul. 3, 2023

(51) Int. Cl. G06F 9/54; G06F 8/20; G06F 8/34

(52) U.S. Cl. CPC G06F 9/54; G06F 8/24; G06F 8/34

(57) ABSTRACT

A request to provide access to a computer program via an application programming interface is received. Based on the request, the computer program is analyzed and a schema for the application programming interface is generated based on the analysis. A resolver code that is operable with the application programming interface is determined. The schema and the resolver code are provided to enable the application programming interface for the computer program.

### BACKGROUND OF THE INVENTION

Workflow solutions enable non-programmers to create functional workflows with little to no programming knowledge. These workflow solutions can be used to implement business related functionalities, such as actions related to HR procedures, IT ticketing, integrations with third-party services, etc. Once a workflow is created, access to the functionality of the workflow is typically provided via a graphical user interface (e.g., a web interface). The graphical user interface can be hosted as a cloud service.

### BRIEF DESCRIPTION OF THE DRAWINGS

Various embodiments of the invention are disclosed in the following detailed description and the accompanying drawings.

FIG. 1 is a block diagram illustrating an example of a network environment for automatically creating application programming interfaces (APIs).

FIG. 2 is a flow chart illustrating an embodiment of a process for creating a workflow with an automatically generated an application programming interface (API).

FIG. 3 is a flow chart illustrating an embodiment of a process for automatically generating an application programming interface (API).

FIG. 4 is a flow chart illustrating an embodiment of a process for automatically generating an application programming interface (API) using a schema and resolver code.

FIG. 5 is a flow chart illustrating an embodiment of a process for resolving calls to an application programming interface (API) to functional components of a computer program.

FIG. 6 is a flow chart illustrating an embodiment of a process for resolving an application programming interface (API) call using an automatically generated API.

FIG. 7 is a functional diagram illustrating a programmed computer system for automatically creating application programming interfaces (APIs).

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Automated application programming interface (API) creation is disclosed. Using the disclosed techniques, an API for a computer program or computer code can be automatically generated by a user with little to no programming knowledge or experience. Moreover, the API can be generated for a computer program or code that itself was generated using a low-code or codeless tool. For example, workflows created using a low-code or codeless tool can have their functionality exposed via a programmatic interface using the disclosed techniques. The automatically generated API for the workflow provides access to functionally formerly inaccessible to third-party or external programs and significantly increases its functionality. For example, external programs including third-party programs can be created that interface with a formerly closed workflow via the automatically generated API. In some embodiments, the API is generated by first creating a schema for the targeted closed program code. The schema can include different fields and types associated with the closed program code and can be created by analyzing the definitions of functions or procedures of the closed program code. For example, input and output arguments can be analyzed to determine an appropriate schema for the computer program code. Using the generated schema and the analysis of the closed program code, resolver code is generated that maps to functionality of the closed program code. For example, each output argument of the computer code can be mapped to resolver code, such as a generated resolver function, that provides a version of a result of the computer program as a response to an API call. In some embodiments, when an exposed field identified by the schema is accessed using the generated API, the API maps the field request to a corresponding resolver function that executes a configured functional process of a previously closed computer program. Using the disclosed techniques, an API can be automatically created that allows increased and flexible access to computer code including low-code or codeless workflow solutions, which otherwise would have no programmatic access.

In some embodiments, a request to provide access to a computer program via an application programming interface is received. For example, a computer program such as a workflow solution is created using a low-code or a codeless graphical user interface tool. As created, the functionality can be inaccessible to outside programs including other workflows. To expose the functionality of the created computer program, a request is initiated to provide access to the computer program via an API. In some embodiments, based on the request, the computer program is analyzed and a schema is generated for the application programming interface based on the analysis. For example, a schema is created that identifies the fields of the computer program and their corresponding types. The identified fields can include the input and output fields (or arguments) of functions of the computer program. In some embodiments, a resolver code is determined that is operable with the application programming interface. For example, resolver code such as resolver functions are generated that map API calls to functional components of the computer program. In some embodiments, the schema and the resolver code are provided to enable the application programming interface for the computer program. For example, the schema and resolver code are provided to create an exposed API for the computer program. In some embodiments, the API generation platform generates API calls for each field identified by the schema including API calls for input and/or output fields. For example, API calls for input fields can be created to modify internal variables utilized by the computer program and API calls for output fields can be created to retrieve values of internal variables utilized by the computer program.

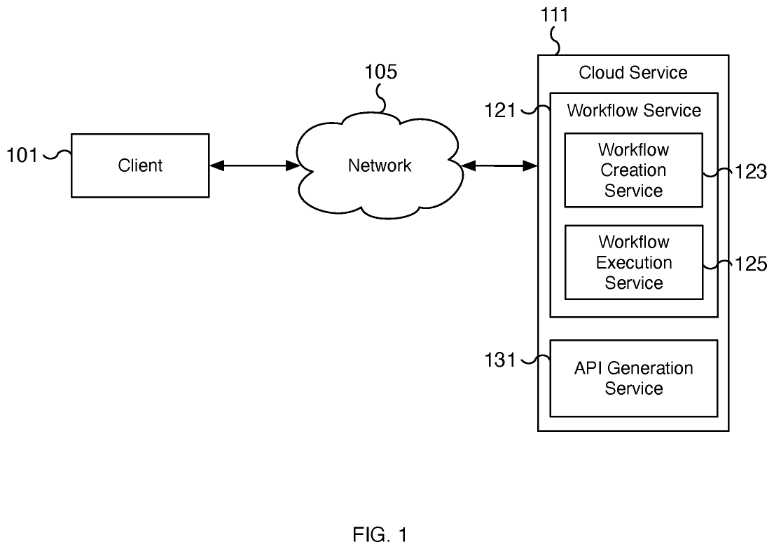

FIG. 1 is a block diagram illustrating an example of a network environment for automatically creating application programming interfaces (APIs). In the example shown, client 101 and cloud service 111 are connected via network 105. Network 105 can be a public or private network. In some embodiments, network 105 is a public network such as the Internet. In various embodiments, cloud service 111 offers multiple application services and includes workflow service 121 and API generation service 131. Cloud service 111 is communicatively connected to client 101 and offers its application services to clients such as client 101. For example, client 101 utilizes workflow service 121 of cloud service 111 to create and execute workflows and further utilizes API generation service 131 of cloud service 111 to create an API for established workflows. The created API allows a workflow's functionality to be exposed to third-party programs and workflows.

In some embodiments, client 101 is an example client for accessing applications services offered by cloud service 111. For example, client 101 can be a network device such as a desktop computer, a laptop, a mobile device, a tablet, a kiosk, a voice assistant, a wearable device, or another network computing device. As a network device, client 101 can access cloud-based services including the ability to create and execute a workflow as well as the ability to expose the functionality of workflow via an automatically generated API. For example, a human resources team member can utilize a web browser or similar application from client 101 to create a workflow for submitting a business expense for reimbursement. The workflow may include multiple sub-flows such as the ability to submit an expense and the ability to check the progress of the expense's reimbursement request. Using the disclosed API generation service, the same (or another) user can expose the functionality of the workflow for programmatic access. For example, additional tools such as an application to monitor the status of outstanding expense reimbursements can leverage the existing workflow and its functionality. In various embodiments, the initial workflow can be created using a low-code or codeless workflow creation tool.

In some embodiments, cloud service 111 is a cloud-based application service that offers multiple cloud services including workflow service 121 and API generation service 131. In the example shown, workflow service 121 includes workflow creation service 123 and workflow execution service 125. In various embodiments, workflow creation service 123 includes a low-code or codeless tool for creating workflows such as integrated services for implementing actions and/or steps for business related functionalities. Example workflows can be created for human resources procedures, information technology ticketing, integrations with third-party services, etc. In various embodiments, the created workflows are hosted by workflow execution service 125 for execution as a cloud service. For example, clients such as client 101 can access a created workflow for execution using workflow execution service 125 of workflow service 111.

In some embodiments, the functionalities of created a workflow, such as a workflow hosted by workflow service 121, is inaccessible outside of the workflow. However, using API generation service 131 of cloud service 111, the functionality of a workflow (or another computer program) can be exposed by requesting the automated generation of an API for a computer program, such as a workflow generated using a low-code or codeless tool. In various embodiments, API generation service 131 analyzes the target computer program (such as a workflow) to create a schema and resolver functions that map a generated API to functionality of the targeted workflow. For example, the workflow and any applicable sub-flows or workflow functions are exposed for access by the generated API. In some embodiments, the generated API is a data query and manipulation API that allows users to retrieve and/or modify values of fields relevant to the targeted workflow (or computer program). In various embodiments, a request to generate an API can be initiated from a client such as client 101.

In some embodiments, the components shown in FIG. 1 may exist in various combinations of hardware machines. Although single instances of some components have been shown to simplify the diagram, additional instances of any of the components shown in FIG. 1 may exist. For example, cloud service 111 can include one or more cloud-based servers including one or more servers for each of workflow service 121 and API generation service 131. The included servers can include distributed servers including web servers, application servers, and database servers, among others. Although cloud service 111 includes workflow service 121 and API generation service 131, other services can be implemented and hosted by cloud service 111 as well. In some embodiments, cloud service 111 only implements API generation service 131 and the target workflows and/or computer programs requiring the automated generation of APIs are hosted elsewhere. As shown in FIG. 1, client 101 is just one example of a potential client to cloud service 111. In some embodiments, components not shown in FIG. 1 may also exist.

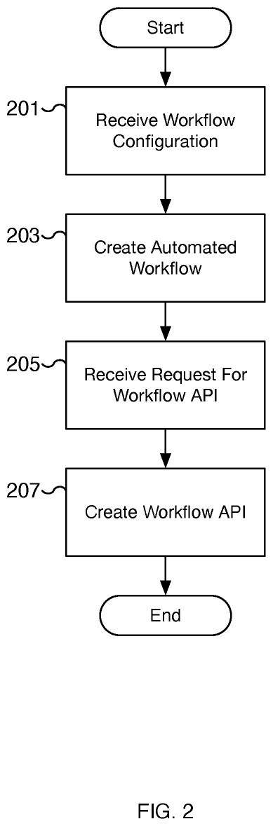

FIG. 2 is a flow chart illustrating an embodiment of a process for creating a workflow with an automatically generated an application programming interface (API). For example, using the process of FIG. 2, a user can request that an API be automatically generated for a workflow such as a workflow created using a low-code or codeless tool. Although described with respect to a workflow, the API generation process of FIG. 2 applies to other computer programs as well including programs created using a traditional programming-based application development environment. In various embodiments, the process of FIG. 2 is performed by cloud service such as cloud service 111 of FIG. 1 and using an API generation service such as API generation service 131 of FIG. 1. In some embodiments, the workflow is created using workflow creation service 123 of FIG. 1 and hosted for execution using workflow execution service 125 of FIG. 1. In some embodiments, the API generation service is hosted as a cloud-based application service and is used to expose workflows created using low-code or codeless tools for programmatic access.

At 201, a workflow configuration is received. For example, a workflow is described using a low-code or codeless workflow generation tool. The workflow can specify input and output arguments along with actions and/or steps to perform. In some embodiments, the workflow can include multiple sub-flows or functions that can be self-contained. For example, a IT ticketing workflow can include a sub-flow for submitting an IT ticket, a sub-flow for querying the status of a submitted ticket, a sub-flow for querying the assigned party responsible for resolving the ticket, a sub-flow for modifying fields of the IT ticket, and a sub-flow for proactively closing the ticket, among others.

At 203, an automated workflow is created. For example, using the configuring parameters received at 201, a corresponding automated workflow is created. The created workflow can be hosted as a cloud-based service that is accessible to clients such as client 101 of FIG. 1. For example, the workflow can be presented as a cloud-based service accessible from a network client. In various embodiments, the functionality of the created workflow is inaccessible outside of the workflow service until an API is created that exposes the workflow functionality.

At 205, a request is received for a workflow API. For example, a request is received to automatically generate an API for the workflow created at 203. The API request can include parameters such as parameters specifying the targeted workflow. In some embodiments, the request includes configuration parameters including access and/or privilege parameters that limit who can access the API and/or the type of access controls to utilize for the API. In some embodiments, the request includes parameters such as whether to include in the generated API read and/or write functionality.

At 207, the workflow API is created. For example, based on the request received at 205, the workflow created at 203 is analyzed and an API for the workflow is created. In various embodiments, the API includes a mapping that translates incoming API calls to workflow functionality. In some embodiments, the created API allows a version of a result of the workflow to be provided in response to a call to the API. The creation of the API can include generating a schema and resolver code for interfacing the API with the workflow functionality. In some embodiments, the generated API is a data query and manipulation API that allows users to retrieve and/or modify values of fields as defined by the generated schema. The created API can be hosted by the API generation service and/or the workflow service.

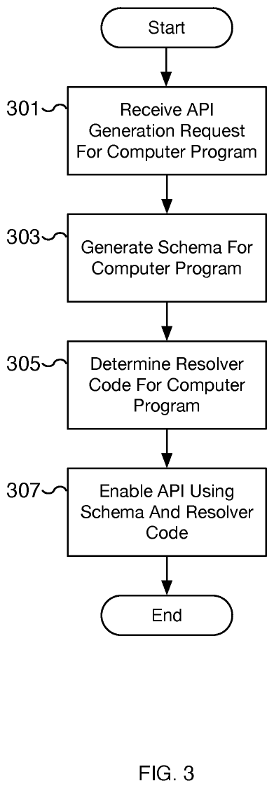

FIG. 3 is a flow chart illustrating an embodiment of a process for automatically generating an application programming interface (API). For example, using the process of FIG. 3, a request received for an API to be automatically generated for a computer program, such as a workflow, is processed and a corresponding API is created and enabled. In some embodiments, the process of FIG. 3 is performed at 205 and/or 207 of FIG. 2 by an API generation service such as API generation service 131 of FIG. 1. In some embodiments, the API generation service is hosted as a cloud-based application service and is used to expose workflows created using low-code or codeless tools for programmatic access.

At 301, an API generation request is received for a computer program. For example, an API generation request is received for a workflow created using a low-code or codeless tool. In some embodiments, the API generation request specifies one or more fields of the computer program to expose via the application programming interface. The request can specify the workflow and the desired configuration parameters of the generated API, such as the type of access to expose and/or the types of security to enforce for access to the generated API. For example, the API generation request can specify read and/or write attributes for fields exposed by the API and/or the type of security framework to utilize for the application programming interface.

At 303, a schema is generated for the computer program. For example, a schema is generated by analyzing the computer program. The schema can identify the relevant fields or functionality of the computer program and their corresponding types. For example, the relevant fields can correspond to the input and output arguments of the workflow and its sub-flows or functions. In some embodiments, the types are determined by analyzing the workflow and can include both primitive and/or basic types as well as complex data types. In various embodiments, one or more fields of the schema correspond to objects of the workflow.

At 305, resolver code is determined for the computer program. For example, one or more resolver functions are determined that resolve an API request to functionality of the computer program. In some embodiments, each field of the computer program is mapped to a resolver function and each resolver function can utilize one or more functional components of the computer program.

At 307, the API is enabled using the schema and the resolver code. For example, using the schema generated at 303 and the resolver code determined at 305, an API is generated for the computer program. In some embodiments, the schema defines the functionality that can be accessed, such as which fields of the computer program can be read and/or modified. In some embodiments, the resolver code is then utilized to map accessed functionality to the functionality of the computer program. In various embodiments, the API can be enabled by hosting the API as a cloud service that can access the computer program. In some embodiments, the computer program is modeled and/or encapsulated as an object and the computer program object is created based on the schema and the resolver code.

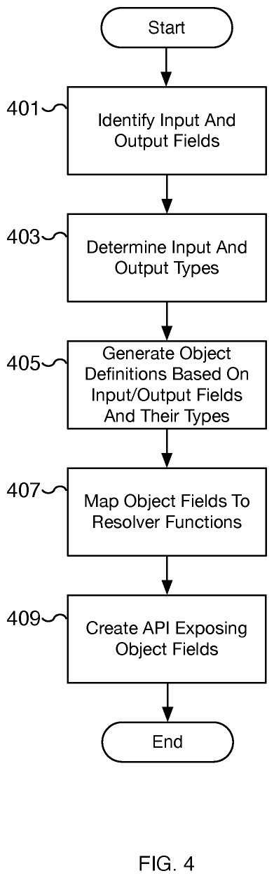

FIG. 4 is a flow chart illustrating an embodiment of a process for automatically generating an application programming interface (API) using a schema and resolver code. For example, using the process of FIG. 4, an API is automatically generated for a computer program, such as a workflow, by analyzing the computer program to create a schema and corresponding resolver code. In some embodiments, the process of FIG. 4 is performed at 205 and/or 207 of FIG. 2 and/or at 303, 305, and/or 307 of FIG. 3 by an API generation service such as API generation service 131 of FIG. 1. In some embodiments, the API generation service is hosted as a cloud-based application service and is used to expose workflows created using low-code or codeless tools for programmatic access.

At 401, the input and output fields are identified. For example, a target computer program is analyzed to identify the input and output fields and/or functionality of the computer program. In some embodiments, the input and output fields correspond to input and output arguments of functions or their equivalents (such as methods for classes) of the computer program. For example, the definition of functions or functional components of the computer program are analyzed to identify the relevant input and output arguments. In some embodiments, the input and output fields include functions and their return values.

At 403, the input and output types are identified. For example, for each input and output field identified at 401, a corresponding type for the field is identified. In some embodiments, the types are identified by analyzing the computer program and its functions or their equivalents (such as methods for classes). In various embodiments, the types can include primitive and/or basic types as well as complex data types including abstract data types. For example, determining complex data types includes navigating the different fields or members (including embedded complex data types) of a data type until all data types are resolved. In some embodiments, the type resolution process is complete when each data type is defined based in terms of primitive and/or basic data types.

At 405, object definitions are generated based on the input and output fields and their types. For example, one or more object definitions are generated for data structures and/or objects relevant to the computer program. In some embodiments, the computer program is modeled as an object and member objects are generated based on the input and output fields identified at 401 and their corresponding types identified at 403. The generated objects and their structure correspond to the fields and/or functionality that will be made accessible by an API for the computer program. In some embodiments, one or more fields of each generated object can include configuration parameters such as read and/or write parameters or attributes that grant the ability for fields to be readable and/or writable. In various embodiments, a version of the object definitions generated at 405 that includes input and output fields identified at 401 and their corresponding types identified at 403 are described and stored as a schema for generating the API.

At 407, the object fields are mapped to resolver functions. For example, each accessible field of a generated object is mapped to a resolver function. In some embodiments, the object fields correspond to API fields that can be read from and/or written to via an API call and the resolver functions are used to map API requests for access to the fields to corresponding functionality of the computer program, such as a workflow or sub-flows of the workflow. In various embodiments, the resolver functions reference workflow functionality and are configured to pass input value to and/or receive output values from the computer program.

At 409, an API exposing the object fields is created. For example, an API is created that exposes the relevant and/or requested fields of the generated object. In various embodiments, an API call can be a predefined API with set arguments and return values. In some embodiments, the generated API is not strictly predefined. For example, the generated API can be a data-based query and manipulation API that allows the referenced and/or specified fields of an API call to be read from and/or modified. Different API calls can include fewer or more fields for querying and/or manipulation. In various embodiments, when an API call is received, the requested fields are accessed by utilizing the resolver functions mapped at 407. For example, when an API call specifies a particular object field, the corresponding resolver function is called. The resolver function in turn executes the corresponding functionality of the computer program. In various embodiments, a version of the return results of the computer program are passed by the resolver function as a return result of the API call.

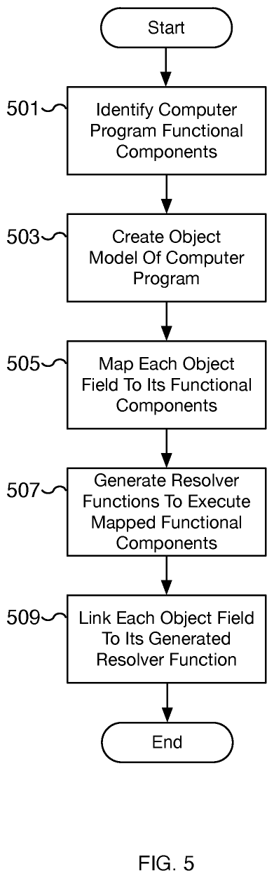

FIG. 5 is a flow chart illustrating an embodiment of a process for resolving calls to an application programming interface (API) to functional components of a computer program. For example, using the process of FIG. 5, an API call can be automatically generated for a computer program, such as a workflow, at least in part by resolving API calls to the correct corresponding functional components of a computer program. In some embodiments, the resolution is performed by resolver functions and a resolver function is configured for each exposed field (or function) of a computer program. In some embodiments, the process of FIG. 5 is performed at 205 and/or 207 of FIG. 2, at 303, 305, and/or 307 of FIG. 3, and/or at 407 of FIG. 4 by an API generation service such as API generation service 131 of FIG. 1. In some embodiments, the API generation service is hosted as a cloud-based application service and is used to expose workflows created using low-code or codeless tools for programmatic access.

At 501, the functional components of a computer program are identified. For example, functions and/or methods of the computer program are identified. In some embodiments, the identified functional components are executable entries for the computer program and can include existing executable functions as well as read/write access to fields such as class members. In various embodiments, the functional components are identified by analyzing the computer program for its structure. For example, the computer program can be parsed to identify functions and variables. As another example, a computer program can be parsed to identify a class with members and methods.

At 503, an object model of the computer program is created. For example, a class is created to encapsulate and model the computer program as an object. The fields of the object are created to correspond to fields of the computer program exposed for access by the API. In some embodiments, the fields of the object are fields that can be read from and/or modified via the API. For example, a field can be queried to return the value of the field as maintained by the computer program. As another example, a field can be modified to set the value of the field to a provided value for use by the computer program. In some embodiments, the fields of the created computer program object correspond to functional components of a computer program identified at 501.

At 505, each object field is mapped to one or more functional components. For example, each fields of the object representation of the computer program created at 503 is mapped to one or more functional components. For example, a field can be mapped to a functional component that retrieves the appropriate return result value or values for the matching field. As another example, a field can be mapped to an existing or newly generated functional component such as an accessor function to modify and/or return the value of a field used by the computer program. In various embodiments, each field accessible for execution, querying, and/or modification via the generated API is mapped to one or more functional components.

At 507, resolver functions are generated to execute the mapped functional components. For example, one or more resolver functions are generated that execute the functional components identified at 501 and mapped at 505. The resolver functions call into the computer program by accessing the computer program's functional components, such as its functions and/or methods. In some embodiments, the resolver functions access values of the computer program by accessing and/or modifying fields of the computer program such as variables and/or members used by the computer program. In various embodiments, the resolver functions correspond to resolver code that can be executed when API calls are received. For example, by executing a resolver function, the incorporated functional components are executed and a version of the return results from executing the incorporated functional components are passed back as a return result of the API call.

At 509, each object field is linked to its generated resolver function. For example, each field exposed by the API is assigned a resolver function for executing its corresponding mapped functional components. The linked resolver functions can return results that are passed back as a return result for an API call. For example, when an object field is referenced in an API call, the corresponding linked resolver function is identified and executed. The execution of the linked resolver function provides a version of a result of the computer program (such as the result from executing a functional component of the computer program) as a response of a call to the API. In some embodiments, multiple fields are referenced in an API call and each field results in the identification and execution of a corresponding linked resolver function. The results from each of the executed linked resolver functions can be returned collectively as a response of the API call.

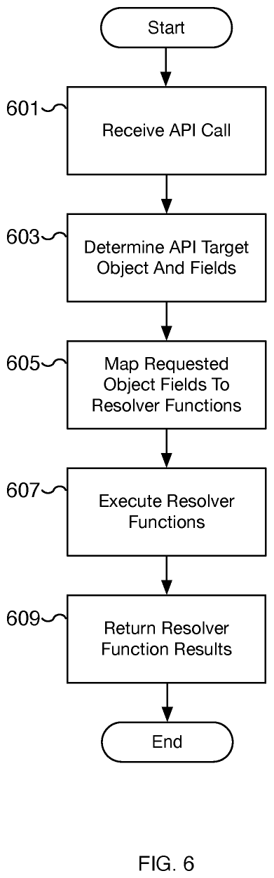

FIG. 6 is a flow chart illustrating an embodiment of a process for resolving an application programming interface (API) call using an automatically generated API. For example, using the process of FIG. 6, an API call is made to an API that is automatically generated for a computer program. The API call is resolved by executing corresponding functional components of the computer program to return a version of a result of the computer program in response to the API call. The API call resolution is performed at least in part by resolver functions configured for the requested API call. In some embodiments, the API generated is a data query and manipulation API that allows users to retrieve and/or modify values of fields identified by an API call. In some embodiments, the process of FIG. 6 is performed once an API has been created using the processed of FIGS. 2-5 by an API generation service and/or workflow service such as API generation service 131 of FIG. 1 and/or workflow server 121 of FIG. 1. For example, the workflow service can host the workflow and the API generation service can receive and return results for API calls by resolving an API call into one or more calls into the workflow service. In some embodiments, the API generation service is hosted as a cloud-based application service and is used to expose workflows created using low-code or codeless tools for programmatic access.

At 601, an API call is received. For example, a call to the API initiated by a client is received. In some embodiments, the API call identifies one or more fields that are the target for a query and/or modification. For example, a query API call can request the return for the current values associated with one or more identified fields. As another example, a modification API call can request setting the values of one or more identified fields to the provided values. In some embodiments, the API call is a request to execute a particular functional component of a computer program.

At 603, an API target object and its fields are determined. For example, the API call received at 601 is analyzed to identify the corresponding target object of the call and any identified fields of the target object. In various embodiments, in generating the API for the computer program, the computer program is encapsulated and/or modelled as one or more objects with one or more fields exposed by the API. At 603, the target object for the API is determined as well as the fields of interest as specified by the API call.

At 605, the requested object fields are mapped to resolver functions. For example, the object fields determined and identified at 603 are mapped to their corresponding configured resolver functions. In some embodiments, each identified field is mapped to a resolver function that can be executed to perform the requested action for the specified field. In some embodiments, a field can be readable and/or writeable. In some embodiments, an identified field corresponds to a variable or member used by the computer program and/or a function or method of the computer program.

At 607, the resolver functions are executed. For example, the mapped resolver functions are executed and as a result they call into or execute functional components of the computer program. In various embodiments, the execution of the resolver functions results in a return value from the computer program. For example, the execution of the resolver functions executes one or more portions of the workflow as provided by a workflow service and results in one or more return results from the workflow. In various embodiments, the executed resolver functions can read and/or modify the state, variables, and/or members of the computer program.

At 609, the resolver function results are returned. For example, the execution of the resolver functions and their subsequent execution of functional components of the computer program at 607 results in one or more return values. The return values resulting from a single API call can be grouped together and provided as a return result or response for the API call. In some embodiments, the return result can correspond to a query API result or a modification API result. For example, a query API result can include the current retrieved values for the specified fields included in the query API call. As another example, a modification API result can include the status codes for setting the values for the specified fields included in the modification API call.

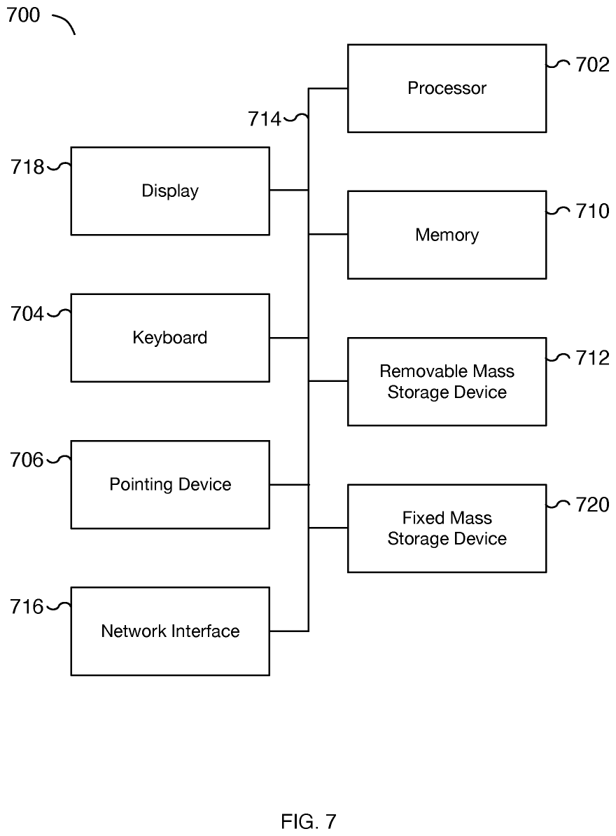

FIG. 7 is a functional diagram illustrating a programmed computer system for automatically creating application programming interfaces (APIs). As will be apparent, other computer system architectures and configurations can be utilized for automatically generating an API for a computer program such as a workflow created using a low-code or codeless tool. Examples of computer system 700 include client 101 of FIG. 1 and/or one or more computers of cloud service 111 of FIG. 1 including one or more computers of workflow service 121 of FIG. 1 and/or API generation service 131 of FIG. 1. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718). In various embodiments, one or more instances of computer system 700 can be used to implement at least portions of the processes of FIGS. 2-6.

Processor 702 is coupled bi-directionally with memory 710, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data and objects used by the processor 702 to perform its functions (e.g., programmed instructions). For example, memory 710 can include any suitable computer-readable storage media, described below, depending on whether, for example, data access needs to be bi-directional or unidirectional. For example, processor 702 can also directly and very rapidly retrieve and store frequently needed data in a cache memory (not shown).

A removable mass storage device 712 provides additional data storage capacity for the computer system 700, and is coupled either bi-directionally (read/write) or unidirectionally (read only) to processor 702. For example, storage 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storages 712, 720 generally store additional programming instructions, data, and the like that typically are not in active use by the processor 702. It will be appreciated that the information retained within mass storages 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
receiving a request to provide access to a computer program via an application programming interface;
analyzing the computer program based on the request, and generating a schema for the application programming interface based on the analysis;
determining a resolver code that is operable with the application programming interface; and
providing the schema and the resolver code to enable the application programming interface for the computer program.

2. The method of claim 1, wherein the resolver code is configured to provide a version of a result of the computer program as a response of a call to the application programming interface.

3. The method of claim 1, wherein determining the resolver code includes generating the resolver code.

4. The method of claim 1, wherein the resolver code includes a resolver function.

5. The method of claim 1, further comprising generating the computer program via a low-code or a codeless graphical user interface tool.

6. The method of claim 1, wherein the request to provide access to the computer program via the application programming interface specifies one or more fields of the computer program to expose via the application programming interface.

7. The method of claim 6, wherein the request to provide access to the computer program includes a read attribute or a write attribute for one or more of the specified one of more fields of the computer program.

8. The method of claim 1, wherein the request to provide access to the computer program via the application programming interface specifies a security framework to utilize for the application programming interface.

9. The method of claim 1, further comprising modeling the computer program as an object.

10. The method of claim 9, wherein one or more fields of the object correspond to one or more fields of the computer program accessible via the application programming interface.

11. A system comprising:
one or more processors; and
a memory coupled to the one or more processors, wherein the memory is configured to provide the one or more processors with instructions which when executed cause the one or more processors to:
receive a request to provide access to a computer program via an application programming interface;
analyze the computer program based on the request, and generate a schema for the application programming interface based on the analysis;
determine a resolver code that is operable with the application programming interface; and
provide the schema and the resolver code to enable the application programming interface for the computer program.

12. The system of claim 11, wherein the resolver code is configured to provide a version of a result of the computer program as a response of a call to the application programming interface.

13. The system of claim 11, wherein determining the resolver code includes generating the resolver code.

14. The system of claim 11, wherein the memory is further configured to provide the one or more processors with instructions which when executed cause the one or more processors to:
generate the computer program via a low-code or a codeless graphical user interface tool.

15. The system of claim 11, wherein the request to provide access to the computer program via the application programming interface specifies one or more fields of the computer program to expose via the application programming interface.

16. The system of claim 15, wherein the request to provide access to the computer program includes a read attribute or a write attribute for one or more of the specified one of more fields of the computer program.

17. The system of claim 11, wherein the request to provide access to the computer program via the application programming interface specifies a security framework to utilize for the application programming interface.

18. The system of claim 11, wherein the memory is further configured to provide the one or more processors with instructions which when executed cause the one or more processors to:
model the computer program as an object.

19. The system of claim 18, wherein one or more fields of the object correspond to one or more fields of the computer program accessible via the application programming interface.

20. A computer program product, the computer program product being embodied in a non-transitory computer readable storage medium and comprising computer instructions for:
receiving a request to provide access to a computer program via an application programming interface;
analyzing the computer program based on the request, and generating a schema for the application programming interface based on the analysis;
determining a resolver code that is operable with the application programming interface; and
providing the schema and the resolver code to enable the application programming interface for the computer program.
